(19) United States
(12) Patent Application Publication
(10) Pub. No.: US 2005/0006237 A1
(43) Pub. Date: Jan. 13, 2005

(54) Ion-selective solid-state polymeric membrane electrondes

(76) Inventors: Colin Patrick Larkin, St. Paul, MN (US); Mark E. Meyerhoff, Ann Arbor, MI (US); Robert Baugh, Parker, CO (US); Narayanan Ramamurthy, Crystal, MN (US)

Correspondence Address: MEDTRONIC, INC., 710 MEDTRONIC PARKWAY NE, MS-LC340, MINNEAPOLIS, MN, 55432-5604, US

(21) Appl. No.: 10/913,592

(22) Filed: Aug. 6, 2004

Related U.S. Application Data
(63) Continuation of application No. 09/573,378, filed on May 18, 2000, now abandoned.

(51) Int. Cl. G01N 27/26; G01N 17/00; G01F 1/64; B05D 5/12

(52) U.S. Cl. 204/416; 204/418; 205/792; 205/793; 427/117; 427/307

(57) ABSTRACT

An improved ion-sensing electrode for detecting ions or polyions is provided having an electrically conducting member sheathed or coated with a layer of insulation except at an exposed, uninsulated area, where the insulation free surface of the electrically conducting member is texturized, and a polymeric membrane coated on the insulation-free surface of the electrically conducting member, where the ion selective membrane includes an ionophore. The texturized surface improves the starting EMF stability and reproducibility of the ion-sensing electrodes, and further improves membrane adherence to the electrically conducting member.

### BACKGROUND OF THE INVENTION

1. Field of the Invention

This invention relates generally to an ion-sensing electrode having an ion-selective membrane in direct contact with a conductive member, and more particularly, to an improved polymer membrane ion-sensing electrode having stable and reproducible starting EMF's, wherein the electrode comprises an ion- or polyion-sensing polymer membrane in direct contact with a texturized surface of a conductive member.

2. Description of the Prior Art

In many settings, for example the clinical laboratory or the analytical or industrial chemical laboratory, the need for rapid analysis of the concentration of a variety of ionic species or analytes in solution exists. In the health care field, particularly in the area of clinical diagnostics, polymer membrane type ion-selective electrodes (ISEs) are now routinely used to measure the activity or concentration of clinically important ions (e.g., Ca²⁺, Na⁺, K⁺, Li⁺, H⁺, and Cl⁻) and metabolites present in biological fluids. Other analytes of particular clinical significance include polyions such as heparin and protamine.

It has been shown recently that polymeric membranes doped with appropriate lipophilic ion-exchangers can be used to conveniently detect low levels of polyion species by simple potentiometry using a classical ion-selective (ISE) electrode configuration. The classical ISE comprises an electrode tube having a silver/silver chloride (Ag/AgCl) electrode inserted into the tube, an ion-selective membrane formed and mounted on one end of an electrode tube, and an internal liquid electrolyte contacting the electrode and the membrane. In these classical ISEs, the polyions are favorably extracted into the polymeric membranes as tight ion-pairs with an ionophore. The desired selectivity of an ISE is often achieved by incorporating an ion selective agent, known as an ionophore, into the polymer membrane of an ion-selective electrode. An ionophore is an ion-selective compound which is capable of complexing a desired ion and extracting it without its counter-ion into the interfacial zone of the membrane. For example, the ionophore valinomycin has been incorporated into a layer of membrane selective for potassium ions; trifluoroacetyl-p-butylbenzene or other trifluoroacetophenone derivatives have been used as ionophores selective for carbonate ions. This basic measurement principle has now been demonstrated for the detection of a wide range of polyionic species at submicromolar levels, including heparin, a highly sulfated polysaccharide anticoagulant (U.S. Pat. No. 5,453,171, to Ma et al.), and protamine, a polycationic antidote to heparin (U.S. Pat. No. 5,607,567 to Yun et al.). It has further been shown that such potentiometric polyion sensors can serve as useful endpoint detectors for monitoring heparin levels in undiluted blood samples via titration with protamine (Ramamurthy et al., Clin. Chem. (1998) 44:606-613), as detectors of peptidase activities (Han et al., FASEB (1996) 10:1621-1626), as detectors for monitoring enzyme assays of serine proteases and their inhibitors (Badr, et al., Anal. Biochem. (1997) 250:74-81) and in the design of novel immunoassay schemes (Dai, et al., J. Pharm. Biomed. Anal (1999) 19:1-14).

In operation, the conventional ISE is immersed in a biological sample solution or a buffer solution of ions for which the electrode is selective, whereby a potential develops across the ion-selective membrane surface at the interface of the solution and the membrane. In a potentiometric sensor, this potential varies with the concentration of ions in solution and its magnitude is measured as a voltage. By comparing the voltage generated at the sensing membrane surface with that generated by a reference electrode using a reference ionic solution, it is possible to calculate the concentration of the ionic species being sought. The potentiometric determination is based upon the principle that the electromotive force (EMF) detected by the voltmeter is proportional to the logarithmic concentration of analyte in solution. Standard solutions of known analyte concentrations are typically used to establish a calibration curve in such analyses, and the concentration of analyte in the test sample is determined by comparison with the calibration curve.

The desire to miniaturize and mass fabricate ion-selective electrodes has led to the development of single-use, polymer-based ISEs with solid internal contact. These electrodes are often referred to in the art as “coated wire electrodes” (CWEs). Coated wire electrodes are solid state ion-selective electrodes having a polymer membrane in direct contact with the internal reference element. Typically, solid state ISEs use a polymer membrane as a sensing element of the electrode, the polymer membrane being highly selective to the ionic species being analyzed. However, the inferior EMF stability of such sensors (compared to conventional electrodes with internal reference electrolyte solutions) limited their routine analytical application. EMF measurements for CWEs tend to drift, have a slow response time, and have irreproducible potential offsets, due to the poorly defined interface between the polymer membrane and internal reference element owing to the absence of a thermodynamically reversible redox couple. This EMF instability in turn causes irreproducible starting potentials of sensors and high EMF drift rates of the output signals, especially after wetting. In addition, minute amounts of water-soluble salt at the interface will cause water uptake, which in turn can cause a drift in potential. Thus, the main limitation to the mass production and routine use of potentiometric solid state sensors was the inferior EMF stability.

Consequently, efforts were directed towards improving the starting EMF stability of the solid-state sensors by establishing a reversible electron transfer pair at the membrane/solid interface. Mussacchio and Oesch (U.S. Pat. No. 5,897,758) proposed the incorporation of a neutral complexing agent (e.g., silver salts of thiocrown ethers or silver benzoate) into the ion-selective polymer films to provide a reversible electrochemical communication with the internal reference element and the membrane. This neutral complexing agent thus serves the same function as the liquid internal reference solution in a conventional ion-sensing electrode.

Liu et al. (Anal. Chim. Acta (1996) 321:173-183) demonstrated that the addition of lipophilic silver-calixarene complexes within sodium and ammonium ion-sensing polymer membranes (prepared with suitable neutral carrier type ionophores) established a reversible electron transfer between the membrane and a solid silver contact, resulting in greatly enhanced EMF stability of solid-state ion sensors fabricated in this way.

Lutze et al. (Fresenius J. Anal. Chem. (1999) 364:41-47) reported the incorporation of lipophilic silver-calixarene complexes along with the required ion-exchangers within polyion-sensing polymeric membranes, where the silver complex serves as a reversible electron transfer agent between the organic polymer film and the underlying solid-state conductor, resulting in more reproducible starting EMF values of these solid state ion sensors.

However, a problem with aforementioned coated wire electrodes is that the silver complexes are light sensitive and tend to degrade over time, thus shortening the lifetime of the solid state ISE. An another problem with coated wire electrodes is the mechanical instability of the electrodes due to poor adhesion of the polymer membrane to the underlying conductive member. Thus, delamination is another determining factor in the lifetime of a solid state ISE.

Another factor impeding commercial application of coated wire electrodes is the lack of a simple, economical commercial process for their manufacture that reliably produces ion-specific electrodes with the same linear response range to a specific ion. Although coated wire electrodes are generally easier to prepare than conventional electrodes, many steps are required in the production of currently available coated wire electrodes, and there is typically significant variation in the sensitivity and precision of coated wire electrodes both within and between batches, thus detracting from the efficiency of commercial production.

For the foregoing reasons there is a need for improved solid state ion selective electrodes having stable and reproducible starting potentials and having little or no failure due to lack of adhesion of the polymer membrane to the internal reference electrode.

### SUMMARY OF THE INVENTION

Accordingly, it is an object of this invention to provide solid-state ion-sensing electrodes having reproducible starting EMF values.

It is another object of this invention to provide solid-state ion-sensing electrodes having improved initial signal stability.

Another object of this invention is to provide solid-state ion-sensing electrodes having improved membrane adhesion and minimal or no failure rates.

A further object of this invention is to provide solid-state ion-sensing electrodes comprising an ion-sensing membrane in direct contact with a texturized end of an electrically conducting member, wherein the design of the electrode eliminates the need to incorporate additional redox species within the membrane.

Still another object of the present invention is to provide an ion-sensing electrode design that facilitates mass manufacturing of ion-sensing electrodes, wherein the ion-sensing electrodes exhibit batch to batch reproducibility, as well as exhibit reproducibility within each batch.

Yet another object of this invention is to provide a method of producing ion-sensing electrodes having an ion-selective membrane in direct contact with an electrically conducting member, wherein the electrode has stable and reproducible starting EMF values, improved membrane adhesion, and improved reliability

Additional objects, advantages and novel features of this invention shall be set forth in part in the description that follows, and in part will become apparent to those skilled in the art upon examination of the following specification or may be learned by the practice of the invention. The objects and advantages of the invention may be realized and attained by means of the instrumentalities, combinations, compositions, and methods particularly pointed out in the appended claims.

To achieve the foregoing and other objects and in accordance with the purposes of the present invention, as embodied and broadly described therein, the present apparatus may comprise an ion-sensing electrode for detecting ions or polyions having an electrically conducting member sheathed with a layer of insulation except at one end, wherein the insulation free portion of the electrically conducting member has a texturized surface, and an ion-selective polymeric membrane coated onto the texturized, insulation-free end of the electrically conducting member, wherein the ion-selective membrane includes an ionophore. The electrically conducting member may be, for example, a wire or a substantially planar, electrically conducting substrate. The ionophore present in the membrane forms a complex with an ion or polyion in a test sample to interface the membrane with the test sample.

To further achieve the foregoing and other objects and in accordance with the purposes of the present invention, as embodied and broadly described therein, another embodiment of this invention comprises a method for producing ion-sensing electrodes for detecting ions or polyions having excellent starting EMF reproducibility and stability, and improved membrane adhesion, and having an ion-selective membrane in direct contact with an electrical conductor. The method of this invention includes the steps of preparing an insulated electrically conductive member having an exposed textured end, preparing a liquid solution comprising an ion-selective polymeric membrane formulation, and dipping the exposed textured end of the electrically conductive member into the liquid solution to form a polymer membrane on the textured end of the electrically conductive member, thereby producing a structurally strong ion-sensing electrode.

To further achieve the foregoing and other objects and in accordance with the purposes of the present invention, as embodied and broadly described therein, another embodiment of this invention comprises a method of measuring an analyte (i.e., an anion or polyion, which may be an anion or a cation) in a liquid medium using an ion-sensing electrode produced according to the method of this invention. In one embodiment, the liquid medium is a biological fluid, such as blood or blood components. In another embodiment, the analyte is heparin or protamine.

### BRIEF DESCRIPTION OF THE DRAWINGS

The accompanying drawings, which are incorporated in and form a part of the specification, illustrate the preferred embodiments of the present invention, and together with the descriptions serve to explain the principles of the invention.

In the Drawings:

FIG. 1 shows a cross-sectional view of one embodiment of an ion-sensing electrode of the present invention; and

FIG. 2 shows a cross-sectional view of a second embodiment of an ion-sensing electrode of the present invention.

### DETAILED DESCRIPTION OF THE PREFERRED EMBODIMENTS

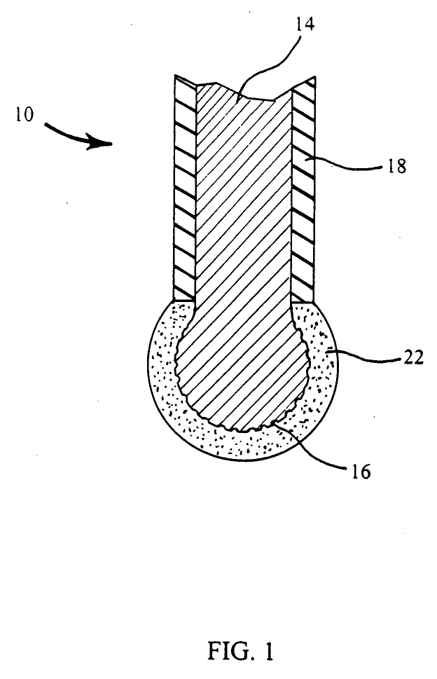

FIG. 1 is a cross-sectional view of one embodiment of an ion-sensing electrode 10 of this invention. The electrode 10 shown in FIG. 1 is generally a coated wire electrode and includes an insulated, electrically conductive member 14 having an exposed (uninsulated) texturized end 16, an electrical insulation layer 18, and an ion-selective membrane 22 formulated as described below which overlays and adheres to the exposed texturized end 16 of electrically conductive member 14. In use, the electrode 10 is wired through a potentiometer to a reference electrode to form a full cell circuit. When the cell is used to measure a titration operation, activity changes in the measured ions are shown as changes in the electric potential or electromotive force (EMF) of the cell.

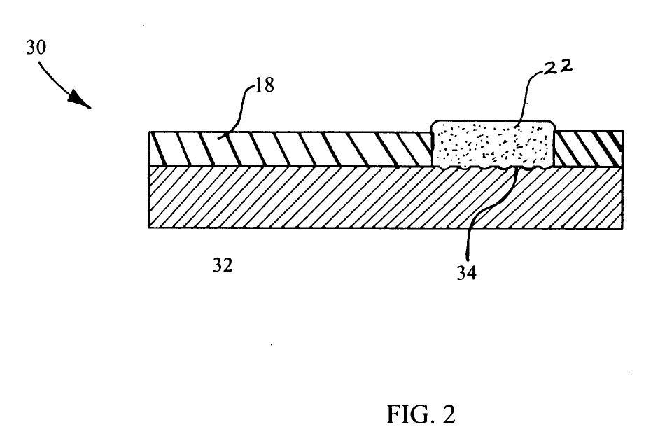

FIG. 2 is a cross-sectional view of another embodiment of an ion sensing electrode 30 of the present invention. The electrode 30 is a substantially planar electrode and includes a thin strip or layer of an electrically conductive member 32, an electrical insulation layer 18 which coats the surface of electrically conductive member 32 except at an uninsulated area 34 which is surrounded by insulation 18, and an ion-selective membrane 22 formulated as described below which completely overlays and coats the uninsulated area 34 of the electrically conductive member 32. The uninsulated area 34 is texturized as described in detail below. The materials for the electrode 30 shown in FIG. 2 are generally the same as for electrode 10 as shown in FIG. 1.

The ion-sensing electrodes 10 and 30 of this invention are useful for potentiometrically determining the presence or concentration of analytes in a liquid medium. The liquid medium may be a non-biological sample such as a saline solution, or it may be a diluted or undiluted biological sample. By “biological sample” is meant any fluid of biological origin including fluids of biological origin which are either untreated (e.g., undiluted) or which have been chemically and/or physically treated, diluted, or concentrated prior to analysis. Examples of biological samples include whole blood, serum, plasma, urine, cerebrospinal fluid, amniotic fluid, saliva, and tears.

The term “analyte” is used interchangeably herein with the term “ion” and refers to the specific component in a liquid medium that is being analyzed. The term “ion” includes small ions and polyions, which may be anions or cations. For example, analytes that may be analyzed by the sensor of this invention include small ions, including but not limited to, potassium (K⁺), sodium (Na⁺), calcium (Ca²⁺), chloride (Cl⁻), hydrogen (H⁺) or bicarbonate (HCO₃⁻), or polyions, including but not limited to, protamine or heparin.

In selecting a suitable electrically conductive member for the electrodes 10 or 30 of the present invention, it is only necessary that the electrically conductive member 14 be capable of being wired to a potentiometer. Aside from this limitation, any electrically conductive material in almost any form may be used. Thus, any conductive metal may be used in forming the electrically conductive member, including, but not limited to, metals such as silver, copper, platinum, gold, palladium, platinum, iridium, aluminum, nickel, stainless steel, iron, and mixtures thereof, the choice of which depends on the performance characteristics sought for a particular application of the sensor. Alternatively, the electrically conductive member of electrodes 10 or 30 may include a mixture of a non-metal substance(s) and a metal or alloy. In one preferred embodiment of an electrode 10 as shown in FIG. 1, the electrically conductive member 14 is a silver wire of 12 to 16 gauge. In another preferred embodiment, the electrically conductive member 14 is a silver wire of 18 to 26 gauge to obtain a miniature electrode. In embodiments such as electrode 30 shown in FIG. 2, the electrically conductive member 32 is substantially planar, wherein the size of the plane will vary in accordance with the design requirements attendant for various applications of the electrode 30. In yet another embodiment the electrically conductive member 14 may be a non-conductive material on which a conductive metal has been screen printed or vacuum deposited. Non-limiting examples of suitable non-conductive materials include glass or polymers such as nylon, high density polyethylene, polypropylene, polycarbonate, or polystyrene.

An electrical insulation layer 18 sheaths the body of electrically conductive member 14, except for the exposed (uninsulated) end 16. The insulating material may be any dielectric material, including poly(vinyl chloride) (PVC), copolymers of poly(vinyl chloride), polymers compatible with poly(vinyl chloride), polyethylene, polypropylene, nylon, polytetrafluorethylene, silicon rubber, and other electrical insulating materials, the use of which would depend on the type and manufacturing requirements of the sensor device.

The uninsulated surface (e.g., surface 16 of electrode 10 or surface 34 of electrode 30) of an electrically conductive member of an electrode of this invention is texturized, for example, by pitting or otherwise roughening the uninsulated surface, or alternatively by screen printing or vacuum depositing silver metal or another suitable conductive metal onto the exposed, uninsulated surface to provide a texturized surface. The texturized surface is then coated with the ion selective membrane 22. As discussed below in detail, the inventors surprisingly and unexpectedly discovered that texturizing the exposed surface of the electrically conductive member provided sensors having reproducible and stable standard potentials and increased sensitivity without the need to incorporate silver complexing agents or other redox materials into the polymer membrane formulation. In addition, the inventors also discovered that texturizing the exposed surface of the electrically conductive member prior to coating exposed, uninsulated surface with the polymer membrane 22 causes the polymer membrane to adhere more strongly to the uninsulated surface of the electrically conductive member when compared to conventional solid state ion selective electrodes wherein the membrane is coated onto a smooth surface, resulting in few or no failures of the ion selective electrodes of this invention. A “failure” as defined herein refers to situation wherein the polymer membrane delaminates or peels away from the electrically conductive member.

The exposed surface of the electrically conductive member is texturized prior to coating the exposed end with the polymer membrane, and, in embodiments such as the coated wire electrode 10 illustrated in FIG. 1, the exposed end 16 is preferably shaped to produce a rounded or convex end 16 prior to texturizing. Methods for rounding the end of a wire are well known to those of skill in the art and include, for example, melt casting and heat forming.

The exposed, uninsulated surface of the electrically conducting member may be texturized by various methods known in the art for texturizing metal. For example, the surface may be texturized by sandblasting or spraying with beads at high pressure. Preferably, the exposed surface of the electrically conductive member is pitted by beadblasting using alumina, glass, or ceramic beads having diameters of approximately 25 to 250 μm, thereby creating pits in the uninsulated surface of the electrically conductive member having diameters of approximately 100 to 250 μm. Alternatively, the exposed surface may be texturized by methods such as screen-printing or chemical vapor deposition of silver or other suitable conductive metals by methods know to persons of skill in the art for constructively forming a textured surface.

In general, the ion selective membrane 22 comprises a polymeric matrix material, a suitable ionophore for detection of the desired ion, and a plasticizer. To form the membrane 22, a liquid mixture is made by dissolving or dispersing the polymer matrix material, an ionophore sensitive to the ion or polyion of interest, and a plasticizer in a suitable solvent. This liquid mixture is then used to form the polymer membrane 22 in the electrode forming process in the manner described below.

Any film forming polymeric material or any material that is capable of being polymerized into a film forming material, or any material which is cross-linkable into a polymeric film, may be used as the polymer matrix material. Suitable polymeric materials which may by used in electrode membranes of this invention include, but are not limited to, synthetic and natural polymeric materials, for example polymers and copolymers of ethylenically unsaturated monomers such as polyethylenes, polybutadienes and the like, polycondensation polymers, such as polyesters, polyamides, polyurethanes, etc., and silicone-based polymers, such as polydimethylsiloxane (e.g., silicone rubber). Such various polymers specifically include, without limitation, polyurethane, cellulose triacetate, and copolymers of poly(vinyl chloride) such as poly(vinyl alcohol)/poly(vinyl chloride) copolymer. For body-invasive, or in-line uses of the ion-sensing electrodes of the invention, the polymeric matrix material should be biocompatible.

The choice of ionophore will depend in part on the desired ion or polyion that is to be analyzed by the solid state ISE of this invention. The term “ionophore” refers to a compound or substrate that is capable of complexing a desired ion and extracting it without a counter-ion into the interfacial zone of the membrane. The ionophore may be an anion exchange material or a cation exchange material. In one preferred embodiment, the ion sensor of this invention is used to detect biologically important polyanionic species in biological fluids such as blood or plasma. Non-limiting examples of polyanionic species which can be detected by the solid state ISE's of this invention include heparin, low molecular weight heparins (LMWH's) including ardeparin sodium (sold under the trademark Normiflo) dalteparin sodium (sold under the trademark Fragmin) and enoxaparin sodium (sold under the trademark Lovenox), sulfated glycosamino glycans (e.g., heparan sulfate, dermatan sulfate, and chondroitin sulfate), carrageenans, and carboxymethyl celluloses. In this embodiment, the anion exchange material is preferably a quatemary ammonium salt. In particularly preferred embodiments of this invention, the quatemary ammonium salt is tridodecylmethylammonium chloride (TDMAC) or trioctylmethylammonium chloride (aliquat 336). Other quatemary ammonium salts which produce a potentiometric response include, without limitation, trimethylphenylammonium chloride, dimethyldioctadecylammonium bromide, tridodecylmethylammonium chloride (TDMAC), trioctylmethylammoniumchloride (aliquat 336), triethylphenylammonium iodide, tetrapentylammonium bromide, tetraoctylammonium bromide, hexadecyltrimethylammonium bromide, tetraethylammonium perchlorate, tetramethylammonium bromide, tetrabutylammonium iodide, polybrene, and other quatemary ammonium salts known to those of skill in the art.

In another preferred embodiment, particularly when the ion-sensing electrodes of this invention are to be used to detect biologically important polycations in biological fluids such as blood or plasma, the ionophore is preferably a negatively charged lipophilic anion. Non-limiting examples of polycations that can be detected by solid state ISE's of this invention include protamine, chymotrypsin, renin, polybrene, poly(arginine), poly(lysine), and other natural or synthetic polycationic peptides such as those containing greater than 50 per cent by weight of arginine or lysine. Other polycations that can be detected by the solid state ISE's of this invention include polymeric molecules such as poly(diallylammonium) and other polymers that have a charge of greater than 10⁺ under physiological conditions (pH 7.4). Suitable ionophores for complexing polycations include salts of organosulfonates, organophosphates or organophosphonates. The organosulfonates, organophosphates, and organophosphonates are less sensitive to small ions, such as potassium ions (K⁺) which are plentiful in blood, for example. A preferred organosulfonate salt is dinonylnaphthalene sulfonate (DNNS), didodecylnaphthalene sulfonate, or dihexadecylnaphthalene sulfonate.

Alternatively, the ionophore in polycation-sensing electrodes of this invention is a salt of an organophosphate or organophosphonate. Preferred salts of organophosphates or organophosphonates include, but are not limited to, tris(2-ethylhexyl) phosphate, dioctylphenyl phosphonate, and calcium bis[4-(1,1,3,3-tetramethylbutyl)phenyl] phosphate. In a particularly preferred embodiment, the ionophore is calcium bis[4-(1,1,3,3-tetramethylbutyl)phenyl] phosphate.

In another particularly preferred embodiments of the invention for detecting polycations, the ionophore is a salt of an organoborate, and preferably the organoborate salts are tetraphenylborate derivatives. Illustrative tetraphenylborate derivatives useful in the practice of the invention include, but are not limited to, sodium tetraphenylborate, potassium tetrakis(4-chlorophenyl) borate, tetraphenylammonium tetraphenyl borate, sodium tetrakis [3,5-bis(trifluoromethyl)phenyl] borate, and potassium tetrakis[3,5-bis(trifluoromethyl)phenyl] borate. In a particularly preferred embodiment, the cation exchange material is potassium tetrakis(4-chlorophenyl) borate.

For a solid-state ISE of this invention for sensing hydrogen ions or pH, a hydrogen ion sensitive ionophore is added into the membrane formulation. Such ionophores include tridodecylamine, 4-nonadecylpyridine, N,N-dioctadecylmethylamine, and octadecylisonicotinate.

For a solid-state ISE of this invention for sensing potassium ions, a potassium ion sensitive ionophore is added into the membrane formulation. Such ionophores include valinomycin, bis[(benzo-15-crown-5)-4′-ylmethyl]pimelate, dimethyl dibenzo-30-crown 10, and 4-nitrobenzo-18-crown-6.

For a solid-state ISE of this invention for sensing sodium ions, a sodium ion sensitive ionophore is added into the membrane formulation. Such ionophores include bis([12-crown-4]-2-methyl)2-methyl-2-dodecylmalonate, N,N′,N′-triheptyl-N,N′,N″-trimethyl-4,4′,4″-propylidynetris (3-oxabutyramide), N,N′-dibenzyl-N,N′-diphenyl-1,2-phenylene-dioxydiacetamide, N,N,N′,N′-tetracyclohexyl-1,2-phenylene-dioxydiacetamide, and 4-octadecanoloxymethyl-N,N,N′,N′-tetracyclohexyl-1,2-phenylenedioxydiacetamide.

One or more plasticizers may be used, alone or in combination, in the membrane composition in order to maintain homogeneity of the mixture, as is known, and in order to control the flux of the polyion analyte to the surface of the membrane from the sample solution and the flux into the bulk of the polymer from the surface of the membrane. In accordance with the principles of the invention, when these two fluxes are equal, a steady-state non-equilibrium response is observed that is far greater than the equilibrium response predicted by a classical ion extraction mechanism governed by the Nernst equation. For this reason, the magnitude and concentration range of ions or polyions detectable by the ion-sensing electrodes of this invention is controlled by the plasticizer/polymer content of the polymer membrane. Of course, the ionophore must be capable of extracting the ion or polyion analyte into the organic phase of the membrane.

A particularly preferred plasticizer, in these embodiments, is 2-nitrophenyl octyl ether (NPOE). However, other plasticizers, including but not limited to, lipophilic alkyl and aryl alcohols, ethers, esters, phosphates, and diphosphonates, are suitable for preparing ion-sensing membranes in accordance with the present invention. Such other plasticizers include, without limitation, dioctyl phthalate, dioctyl sebacate, dioctyl adipate, dibutyl sebacate, dibutyl phthalate, 1-decanol, 5-phenyl-1-pentanol, tetraundecyl benzhydrol 3,3′,4,4′ tetracarboxylate, benzyl ether, dioctylphenyl phosphonate, tris(2-ethylhexyl) phosphate, and fluorophenyl nitrophenyl ether. In selecting a plasticizer(s) for the polymeric membrane, it is important that the plasticizer be compatible with the polymeric matrix material. Incompatibility manifests itself, for example, by exudation of the plasticizer during curing, or by the formation of an opaque membrane. The result of incompatibility is membranes having shorter lifetimes and less reproducibility. In embodiments using a silicone rubber as the polymeric matrix material, it is preferable to use the plasticizer tetradodecylmethylammonium tetrakis(4-chlorophenyl)borate (ETH 500) to reduce membrane impedance.

Selectivity and sensitivity of the ion selective membranes are affected by the contents of the polymeric membranes. In preferred embodiments, the membranes comprise about 0.1-5 weight percent ionophore, about 30-70 weight percent polymeric matrix material, and about 30-70 weight percent plasticizer. The preferred ionophore content is between about 1.0 and 1.5 weight percent. The preferred polymer/plasticizer ratio is between the values of about 1.0 and 1.5.

In a particularly preferred embodiment of an ion-sensing electrode for sensing protamine in solution, for example in biological fluids such as plasma, the ion-sensing membrane comprises about 1.0 weight percent dinonylnaphthalenesulfonate (DNNS) as the ionophore, 49.5 weight percent poly(vinyl chloride) (PVC) as the polymeric matrix material, and 49.5 weight percent 2-nitrophenyloctyl ether (NPOE) as the plasticizer. In another particularly preferred embodiment for sensing protamine, the ion-sensing membrane comprises 1.0 weight percent bis[4-(1,1,3,3-tetramethylbutyl)phenyl] phosphate calcium salt as the ionophore, 49.5 weight percent poly(vinyl chloride) (PVC) as the polymeric matrix material, and 49.5 weight percent tris(2-ethylhexyl) phosphate as the plasticizer.

In another particularly preferred embodiment of an ion-sensing electrode for sensing heparin in solution, the ion-sensing membrane comprises about 1.5 weight percent tridodecylmethylammonium chloride (TDMAC) as the ionophore, 65,7 weight percent poly(vinyl chloride) (PVC) as the polymeric matrix material, and 32.8 weight percent dioctyl sebacate (DOS) as the plasticizer.

In certain preferred embodiments, the ion-sensing membrane is prepared as a homogenous solution of the polymeric matrix material, plasticizer, and ionophore in an organic solvent, such as tetrahydrofuran (THF), dimethylformamide (DMF), or cyclohexanone. In those embodiments wherein the polymeric matrix material is silicone rubber, the ionophore preferably is combined with the silicone rubber after the silicone rubber has been dissolved in a suitable solvent. The homogeneous solution is coated and/or layered onto a pitted or texturized surface of a conductive metallic substrate or surface, such as a conductive wire.

One process according to the present invention for making an embodiment corresponding to electrode 10 illustrated in FIG. 1 generally comprises preparing a fresh conductive surface by cutting through the insulation 18 of an insulated metallic wire, thereby exposing a fresh metallic surface at the end 16 of electrically conductive member 14. The exposed end 16 optionally may be rounded or curved by methods known to those of skill in the art for rounding an end of a metal wire, such as by melt casting or heat forming. The exposed, optionally rounded end 16 is then texturized as described above, such as by beadblasting exposed end 16. In an alternate embodiment, the texturized end 16 is formed by screen printing or vacuum depositing a conductive metal onto exposed end of a non-conductive substrate.

The textured end 16 is then dipped into a prepared liquid solution of an ion selective membrane formulation containing a polymer, solvent, plasticizer, and a specific ion-sensing ionophore to completely coat the exposed pitted end 16. The solvent is then evaporated from the coating to form an ion selective membrane 22 over pitted or textured end 16. The thickness of the polymer membrane formed on texturized end 16 will depend in part on the viscosity of the liquid solution and the number of times the textured end 16 is dipped into the solution. Preferably, the thickness of the polymer membrane is between about 50-250 microns.

An alternative method according to the present invention for making an embodiment corresponding to electrode 10 generally comprises forming an insulation layer 18 around a metal wire 14 in a manner which allows end 16 to remain free of insulation, and optionally rounding end 16. The exposed end 16 is then texturized as described above, and the texturized end 16 is dipped into a prepared liquid solution of an ion selective membrane formulation containing a polymer, solvent, plasticizer, and a specific ion-sensing ionophore to completely coat the exposed, texturized end 16. The solvent is then evaporated from the coating to form an ion selective membrane 22 at end 16 of electrode 10. Alternatively, end 16 may be pitted prior to forming an insulation layer 18 around metal wire 14.

In another embodiment of the process of this invention, the electrode 30 as shown in FIG. 2 comprises coating a layer of insulating onto a metallic strip 32 except for a selected area 34 that remains free of insulation; texturizing the uninsulated surface 34 as described above; making a liquid solution of an ion-selective membrane formulation; and coating the texturized surface 34 with the ion-selective membrane formulation.

As stated above, a key issue in the design of solid state ISEs has been defining the interface between the ion-sensing polymer membrane and the electrically conductive element in order to obtain stable, reproducible starting potentials. Until the present invention, the primary method of defining the interfacial potential in solid state ISEs was to add redox species such as silver complexes to the polymer membrane formulation.

It has surprisingly been found that the texturized surface of an electrically conductive member of an electrode of this invention provides solid state ISEs with stable, reproducible starting EMF values that are equivalent or better that those achieved in solid state ISEs comprising redox species (e.g., silver complexes) in the polymer membrane. Thus, the present invention provides solid state ISEs that are not dependent on redox species. As a result of the design of the solid state ISE of this invention, it is no longer necessary to add redox species such as silver complexes to the polymer membrane formulation in order to achieve stable and reproducible starting EMFs.

Four batches of coated wire, solid state ISEs as shown in FIG. 1 were prepared according to Example 1 and evaluated by measuring the potentials of the electrodes verses a silver/silver chloride reference electrode. The results of this study are tabulated in Table 1, which show that a high reproducibility of the starting EMF values was found, demonstrating that a reproducible phase boundary potential exists-at the membrane/conductive member interface. In this experiment, the batch numbers 27, 50, 71, and 90 refer to the batch of sensors made by the method of this invention from which the sensor was taken to test the blood samples. Table 1 shows that each of the sensors from batches 27, 50, 71, and 90 showed good reproducibility within the samples tested for each sensor.

When the sensor from batch 27 was used to measure the heparin concentration in sample numbers 1-13, the reference electrode was washed with deionized water between sample measurements. As can be seen from Table 1, the starting potentials for the sensor from batch 27 when measuring samples M-1 through M-13 are higher and tend to drift upwards as compared measurements of samples 14-43. It was believed that the starting potentials for the sensor from batch 27 when measuring sample numbers 1-13 were higher because of reference electrode “fouling”, that is, plasma protein adsorption may have caused successively increasing starting potentials for the measurements of sample numbers 1-13. Consequently, in-subsequent sample measurements of samples 14-43, the reference electrode was washed with diluted HCl between measurements to remove any proteins adsorbed onto the reference electrode surface. Thus, the starting potentials for sensors when measuring sample numbers 14-43 lower than those for the sensor from batch 27. In addition, the starting potentials for sensors used to measure sample numbers 14-43 are more reproducible than those for the sensor measuring sample numbers 1-13.

The solid state ISEs of this invention were then characterized with the respect to the magnitude of response towards the polycation protamine. Table 2 summarizes the results of potentiometric titrations of various heparin preparations with protamine using protamine-sensitive electrodes of the invention. The electrodes used in this experiment, prepared according to Example 1, comprised polymeric membranes doped with the charged cation exchanger dinonylnaphthalenesulfonate (DNNS), and the ends 16 of electrically conductive members 14 were texturized by beadblasting with alumina beads. In this experiment, the concentration of heparin was determined by monitoring the EMF during potentiometric titrations of the heparin in blood samples with protamine. Protamine is a heparin neutralizer and binds stoichiometrically to heparin. The titrations were performed by providing a continuous infusion of a 2 mg/mL protamine solution into heparinized citrated whole blood samples. The resulting change in potential over time was monitored by the protamine sensitive electrodes prepared by the methods of this invention. The presence of heparin in the sample causes a shift in the time required for the electrode to reach the end-point (i.e., the point where the amount of protamine in the sample equals the amount of heparin in the sample). Consequently, the heparin concentration can be determined from the time taken to reach the end-point by knowing the infusion rate and the protamine concentration in the titrant solution being added to the heparinized sample. Titrations 1 and 2 shown in Table 2 were performed on blank samples. The converted values shown in Table 2 are the actual measured values minus the blank values. Multiple automated titrations were performed on samples spiked with varying levels of heparin (2.0, 4.0, and 6.0 U ml⁻¹) and showed good accuracy and precision (1.88±0.09, 4.00±0.20, and 6.00±0.08 U⁻¹, respectively). All of the electrodes exhibited reproducible and rapid potentiometric responses to protamine over the concentration range of 2-6 units per liter (U/L).

A significant and surprising discovery of the ion-sensing electrodes of this invention is that the texturized surface of the electrically conducting member improves the reproducibility and stability of starting EMF values, consequently eliminating the need to incorporate additional redox species such as silver-ligand complexes into the membrane formulation in order to provide an internal contact between the membrane and the electrically conductive member. The resulting sensors perform well and are not susceptible to degradation, which is a problem in prior art sensors due to decomposition of light-sensitive silver complexes.

A further advantage is that the texturized surface of the electrically conductive member eliminates the need to incorporate additional compounds into the polymer membrane formulation to improve membrane adhesion to the electrically conductive member. Thus, the design of ion-sensing electrodes of this invention reduces the cost of manufacture of the sensors by eliminating costly components used in prior art sensors.

The inventors also discovered that the texturized end 16 resulted in excellent polymer membrane adhesion to the electrically conductive member. As noted above, while ion-sensing electrodes having a polymer membrane in direct contact with the electrically conductive member are known in the art, the problem of maintaining good adhesion of the polymer membrane to the electrically conductive member has remained a challenge. The present inventors surprisingly and unexpectedly discovered that providing a roughened or textured surface on the electrically conductive member, for example by pitting or beadblasting an exposed, uninsulated surface of the electrically conductive member, allows the polymer membrane 22 to adhere more strongly to end 16 than in electrodes that do not have a polymer membrane coating a textured surface. In fact, the inventors prepared numerous ion-sensing electrodes 10 according to the method of this invention, wherein all of the electrodes prepared were observed to have 100 percent success rate. That is, membrane 22 remained firmly adhered to the electrically conductive member 14 in all of the electrodes 10 prepared according to this invention throughout the use of the electrodes during routine potentiometric measurements of ions in solution. While not wishing to be bound by theory, the inventors believe that texturizing end 16 of electrically conductive member 14 provides a porous or rough surface which in turn provides a good anchor for membrane 22, and consequently allows membrane 22 to adhere more strongly to electrically conductive member 14.

A further advantage of the ion-sensing electrodes of this invention is the mechanical stability achieved by creating a textured surface on the exposed end of the electrically conductive member to be coated with the ion-sensing membrane, thereby ensuring that the membrane will adhere sufficiently to the electrically conducting member such that the failure rates of the electrodes of this invention are minimal. The texturized end of the electrically conductive member was discovered to provide a better bonding surface for the polymer membrane, thus improving the adhesion of the membrane to the electrically conductive member. This improved mechanical stability makes the ion-sensing electrodes 10 of this invention less fragile and easier to manufacture and use. A further advantage of the improved mechanical stability is extended shelf life as well as increased operational lifetime.

Another important advantage of the ion-sensing electrodes of this invention is that the possible combinations of ion selective electrodes which can be formed by the method of this invention is almost unlimited, so that an entire range of potentiometrically responsive ion selective electrodes can be produced in inexpensive, compact form.

The ion-sensing electrodes of this invention may be used in numerous applications, including many clinical applications, for the detection and measurement of ions and polyions in solutions. For example, the ion-sensing electrodes of this invention doped with appropriate lipophilic ion-exchangers display potentiometric response (EMF) to biologically important polyionic species (e.g., heparin, protamine, polyphosphates, DNA, etc.). The sensors exhibit potentiometric responses to sub-micromolar levels of polyions in samples as complex as whole blood.

The present invention provides a method of preparing ion-sensing electrodes having a polymer membrane in direct contact with the electrically conductive member wherein the membrane remains firmly attached to the electrically conductive member.

### EXAMPLE 1

Polytetramethyleneglycol ether thermoplastic polyurethane, sold under the trademark Pellethane, was purchased from Dow Chemical Co. (Midland, Mich.). The polymer M48 was provided by Medtronic, Inc. The plasticizer 2-nitrophenyl octyl ether (NPOE) was purchased from Fluka Chemica Biochemika (Ronkonkoma, N.Y.). The ion-exchanger dinonylnaphthalenesulfonate (DNNS) was purchased from King Industries (Norwalk, Conn.). The ter-polymer of poly(vinyl chloride)/poly(vinyl acetate)/poly(hydroxypropyl acrylate) (80%:15%:5%) was purchased from Scientific Polymer Products (Ontario, N.Y.). Tetradodecylmethylammonium tetrakis(4-chlorophenyl)borate (ETH 500) was purchased from Fluka (Ronkonkoma, N.Y.). Heparin (from porcine mucosa) and protamine (from herring) were purchased from Sigma Chemical Co. (St. Louis, Mo.).

In a specific illustrative embodiment of the invention, an ion-sensing electrode was prepared by the following method: an exposed end of an insulated silver wire was pitted by blasting with alumina beads having diameters from 20 to 50 μm. The pitted end was dipped in a polymer membrane formulation comprising 19.8 wt % M48, 39.7% pellethane, 30.1 wt % NPOE, 2.1 wt % DNNS, 8 wt % ter-polymer, 0.3 wt % ETH 500, and sufficient tetrahydrofuran to dissolve the polymer membrane formulation components.

The concentration of heparin was determined by monitoring the EMF during potentiometric titrations of the heparin in blood samples with protamine. The ion-sensing electrode along with a referenced electrode were placed in a 1 mL glass vial which was then filled with 1 mL of citrated whole blood spiked with differing amounts of heparin. The titrations were performed by providing a continuous infusion of a protamine solution (2 mg/mL) into the glass vial at 5 μL/min using a syringe pump. The change in the EMF response was monitored using a millivoltmeter. Endpoints were computed by using one-half of the maximum EMF change.

Multiple automated titrations performed on samples spiked with varying levels of heparin (2.0, 4.0, and 6.0 U/mL) showed good accuracy and precision (1.88±0.09, 4.00±0.20, and 6.00 ±0.08 U/mL, respectively). All of the electrodes exhibited reproducible and rapid potentiometric responses to protamine over the concentration range of 2-6 units per milliliter (U/mL).

The foregoing description is considered as illustrative only of the principles of the invention. The words “comprise,” “comprising,” “include,” “including,” and “includes” when used in this specification and in the following claims are intended to specify the presence of stated features, integers, components, or steps, but they do not preclude the presence or addition of one or more other features, integers, components, steps, or groups thereof. Furthermore, since a number modifications and changes will readily occur to those skilled in the art, it is not desired to limit the invention to the exact construction and process shown described above. Accordingly, all suitable modifications and equivalents may be resorted to falling within the scope of the invention as defined by the claims that follow.

TABLE 1

| Sample | | | | | | | | | | Std. |
|---|---|---|---|---|---|---|---|---|---|---|
| number | Donor | Batch | Cal-1 | Cal-2 | Cal-3 | Titrn-1 | Titrn-2 | Titrn-3 | Average | Dev. |
| 1 | M-1 | 27 | 331 | 327 | 331 | 319 | 333 | 335 | 329.3 | 5.2 |
| 2 | F-1 | 27 | 336 | 339 | 337 | 336 | 333 | 328 | 336.5 | 1.9 |
| 3 | F-2 | 27 | 343 | 342 | 346 | 343 | 344 | 344 | 343.7 | 1.2 |
| 4 | M-2 | 27 | 338 | 339 | 342 | 343 | 344 | 341 | 341.2 | 2.1 |
| 5 | F-3 | 27 | 343 | 349 | 343 | 346 | 345 | 347 | 345.5 | 2.1 |
| 6 | F-4 | 27 | 347 | 342 | 345 | 342 | 345 | 341 | 343.7 | 2.1 |
| 7 | F-5 | 27 | 349 | 348 | 341 | 349 | 354 | 350 | 348.5 | 3.9 |
| 8 | M-3 | 27 | 354 | 351 | 355 | 352 | 349 | 350 | 351.8 | 2.1 |
| 9 | F-6 | 27 | 359 | 354 | 353 | 348 | 357 | 358 | 354.8 | 3.7 |
| 10 | M-4 | 27 | 355 | 358 | 351 | 354 | 350 | 360 | 354.7 | 3.5 |
| 11 | M-5 | 27 | 356 | 350 | 352 | 355 | 355 | 363 | 355.2 | 4.1 |
| 12 | F-7 | 27 | 369 | 372 | — | 370 | 370 | — | 374.9 | 4.3 |
| 13 | M-6 | 27 | 383 | 375 | — | 383 | 384 | — | 383.0 | 3.1 |
| 14 | F-8 | 27 | 305 | 299 | — | 299 | 299 | — | 300.2 | 2.5 |
| 15 | M-7 | 27 | 298 | 299 | — | 300 | 292 | — | 298.1 | 2.6 |
| 16 | M-8 | 27 | 295 | 295 | — | 294 | 297 | — | 295.9 | 1.6 |
| 17 | M-9 | 27 | 297 | 304 | — | 303 | 297 | — | 299.8 | 3.2 |
| 18 | F-9 | 27 | 301 | 299 | — | 301 | 285 | — | 293.2 | 5.7 |
| 19 | M-10 | 27 | 293 | 293 | — | 294 | 300 | — | 296.0 | 2.4 |
| 20 | M-11 | 27 | 296 | 287 | — | 290 | 319 | — | 298.2 | 8.5 |
| 21 | M-12 | 27 | 288 | 291 | — | 292 | 292 | — | 292.2 | 2.0 |
| 22 | F-10 | 50 | 310 | 315 | — | 321 | 317 | — | 316.5 | 3.1 |
| 23 | M-14 | 50 | 315 | 320 | — | 317 | 328 | — | 319.3 | 3.8 |
| 24 | F-11 | 50 | 319 | 315 | — | 316 | 311 | — | 315.8 | 2.2 |
| 25 | M-15 | 50 | 315 | 316 | — | 317 | 316 | — | 315.8 | 1.5 |
| 26 | F-12 | 50 | 306 | 303 | — | 301 | 304 | — | 303.8 | 2.3 |
| 27 | F-13 | 50 | 298 | 294 | — | 296 | 298 | — | 297.2 | 1.7 |
| 28 | M-16 | 50 | 297 | 304 | — | 306 | 303 | — | 297.6 | 5.3 |
| 29 | F-14 | 50 | 301 | 301 | — | 302 | 299 | — | 299.8 | 2.0 |
| 30 | F-15 | 50 | 299 | 306 | — | 297 | 295 | — | 299.8 | 3.2 |
| 31 | F-16 | 50 | 304 | 295 | — | 304 | 294 | — | 298.4 | 4.4 |
| 32 | F-17 | 50 | 298 | 298 | — | 301 | 299 | — | 300.2 | 1.9 |
| 33 | F-18 | 50 | 304 | 305 | — | 306 | 301 | — | 303.0 | 2.5 |
| 34 | M-17 | 50 | 300 | 295 | — | 298 | 300 | — | 298.1 | 2.1 |
| 35 | M-18 | 50 | 291 | 293 | — | 300 | 295 | — | 295.3 | 3.7 |
| 36 | F-19 | 50 | 297 | 300 | — | 299 | 298 | — | 298.6 | 1.3 |
| 37 | F-20 | 50 | 294 | 285 | — | 292 | 299 | — | 292.6 | 3.9 |
| 38 | M-19 | 50 | 292 | 286 | — | 297 | 291 | — | 290.8 | 3.5 |
| 39 | F-21 | 50 | 297 | 293 | — | 289 | 284 | — | 291.4 | 3.9 |
| 40 | M-20 | 71 | 310 | 303 | — | 297 | 300 | — | 304.9 | 4.7 |
| 41 | M-21 | 71 | 303 | 301 | — | 303 | 304 | — | 299.4 | 3.6 |
| 42 | F-22 | 71 | 298 | 294 | — | 295 | 297 | — | 295.8 | 1.2 |
| 43 | M-22 | 90 | 292 | 294 | — | 292 | 299 | — | 296.3 | 4.4 |

cal = calibration
titrn = titration

TABLE 2

| | | Endpoint Calculations (sec.) | | | | | | | | | |
|---|---|---|---|---|---|---|---|---|---|---|---|
| | Heparin | | | | Converted value | | | Calculated heparin | | Avg. Calc'd | |
| | concentration | Actual value | | | | | Converted | concentration (U/mL) | | [heparin] | |
| Titration # | (U/mL) | Sensor 1 | Sensor 2 | Average | Sensor 1 | Sensor 2 | Average | Sensor 1 | Sensor 2 | (U/mL) | % difference |
| 1 | | 27 | 30 | 27 | | | | | | | |
| 2 | | 27 | 25 | | | | | | | | |
| 3 | 2 | 87 | 80 | 84 | 60 | 53 | 56 | 1.99 | 1.76 | 1.88 | −5.97 |
| 4 | 2 | 82 | 83 | | 55 | 56 | | 1.83 | 1.86 | | |
| 5 | 2 | 86 | 84 | | 59 | 57 | | 1.96 | 1.89 | | |
| | | | | | | | | Max: 1.99 | | | |
| | | | | | | | | Min: 3.76 | | | |
| | | | | | | | | Std. Dev. 0.09 | | | |
| 6 | 4 | 149 | 146 | 147 | 122 | 119 | 120 | 4.06 | 3.96 | 4.00 | −0.07 |
| 7 | 4 | 154 | 153 | | 127 | 126 | | 4.23 | 4.19 | | |
| 8 | 4 | 140 | 141 | | 113 | 114 | | 3.76 | 3.79 | | |
| | | | | | | | | Max: 4.23 | | | |
| | | | | | | | | Min: 3.76 | | | |
| | | | | | | | | Std. Dev. 0.20 | | | |
| 9 | 6 | 210 | 205 | 2.07 | 183 | 178 | 180 | 6.09 | 5.93 | 6.00 | −0.05 |
| 10 | 6 | 209 | 209 | | 182 | 182 | | 6.06 | 6.06 | | |
| 11 | 6 | 205 | 205 | | 178 | 178 | | 5.93 | 5.93 | | |

Max: 6.09
Min: 5.93
Std. Dev. 0.08

1-68. (canceled)

69. An ion-sensing electrode comprising:
an electrically conductive member having a textured surface; and
an ion-selective polymer membrane that completely coats and is in direct contact with the textured surface of said electrically conductive member, said membrane comprising an ionophore responsive to protamine or heparin.

70. The ion-sensing electrode of claim 69 further comprising a layer of electrical insulation surrounding said electrically conductive member, wherein the textured surface of said electrically conductive member is uninsulated.

71. The ion-sensing electrode of claim 69 wherein said electrically conductive member is selected from the group consisting of silver, copper, platinum, gold, palladium, iridium, aluminum, nickel, stainless steel, iron, and an electrically conductive metal deposited onto a portion of a non-conductive substrate.

72. The ion-sensing electrode of claim 69 wherein said ion-selective polymer membrane further comprises a polymeric matrix material and a plasticizer.

73. The ion-sensing electrode of claim 69 wherein said ionophore responsive to protamine is a negatively charged lipophilic anion.

74. The ion-sensing electrode of claim 73 wherein the negatively charged lipophilic anion is derived from a salt of an organosulfonate, organoborate, organophosphate or organophosphonate.

75. The ion-sensing electrode of claim 74 wherein said salt of a sulfonate is dinonylnaphthalene sulfonate, didodecylnaphthalene sulfonate, or dihexadecylnaphthalene sulfonate.

76. The ion-sensing electrode of claim 74 wherein said salt of an organoborate is a salt of a tetraphenylborate selected from the group consisting of sodium tetraphenylborate, potassium tetrakis(4-chlorophenyl) borate, tetraphenylammoniumtetraphenyl borate, sodium tetrakis[3,5-bis(trifluoromethyl)phenyl]borate, and potassium tetrakis[3,5-bis(trifluoromethyl)phenyl]borate.

77. The ion-sensing electrode of claim 76 wherein the salt of a tetraphenylborate is potassium tetrakis(4-chlorophenyl) borate.

78. The ion-sensing electrode of claim 74 wherein said salt of an organophosphate or organophosphonate is selected from the group consisting of calcium bis[4-(1,1,3,3,-tetramethylbutyl)phenyl] phosphate, dioctylphenyl phosphonate, and tris(2-ethylhexyl) phosphate.

79. The ion-sensing electrode of claim 78 wherein said salt of an organophosphate is calcium bis[4-(1,1,3,3,-tetramethylbutyl)phenyl] phosphate.

80. The ion-sensing electrode of claim 69 wherein said ionophore responsive to heparin is selected from the group consisting of quaternary ammonium salts, quaternary phosphonium salts, and quaternary arsonium salts.

81. The ion-sensing electrode of claim 80 wherein said ionophore is a quaternary ammonium salt.

82. The ion-sensing electrode of claim 80 wherein said quaternary ammonium salt is selected from the group consisting of triethylphenylammonium iodide, tetrapentylammonium bromide, trimethylphenylammonium chloride, dimethyldioctadecylammonium bromide, tetraoctylammonium bromide, hexadecyltrimethylammonium bromide, tetraethylammonium perchlorate, tetramethylammonium bromide, tetrabutylammonium iodide, tridodecylmethylammonium chloride, polybrene, and trioctylmethylammoniumchloride

83. The ion-sensing electrode of claim 82 wherein said quaternary ammonium salt is tridodecylmethylammonium chloride.

84. The ion-sensing electrode of claim 72 wherein said polymer matrix material is a film-forming, hydrophobic polymer or copolymer.

85. The ion-sensing electrode of claim 84 wherein said polymeric matrix material is selected from the group consisting of poly(vinyl chloride), polyurethane, cellulose triacetate, poly(vinyl alcohol)/poly(vinyl chloride) copolymer, and silicone rubber.

86. The ion-sensing electrode of claim 85 wherein said polymeric matrix material is poly(vinyl chloride).

87. The ion-sensing electrode of claim 72 wherein said plasticizer is one or more plasticizers selected from the group consisting of 2-nitrophenyl octyl ether, dioctyl phthalate, dioctyl sebacate, dioctyl adipate, dibutyl sebacate, dibutyl phthalate, 1-decanol, 5-phenyl-1-pentanol, tetraundecyl benzhydrol 3,3′,4,4′ tetracarboxylate, benzyl ether, dioctylphenyl phosphonate, tris(2-ethylhexyl) phosphate, and fluorophenyl nitrophenyl ether.

88. The ion-sensing electrode of claim 87 wherein said plasticizer is 2-nitrophenyloctyl ether.

89. The ion-sensing electrode of claim 87 wherein said plasticizer is tris(2-ethylhexyl) phosphate.

90. The ion-sensing electrode of claim 72 wherein said ion-selective polymer membrane comprises, in admixture, about 0.1 to 5 percent by weight of said ionophore selective for protamine or said ionophore selective for heparin, about 30 to 70 percent by weight of said plasticizer, and about 30 to 70 percent by weight of said polymer matrix material.

91. A method for producing an ion-sensing electrode having a structurally strong ion selective membrane, said method comprising:
a) forming an electrically conductive member electrically insulated with a layer of electrical insulation, said conductive member having an uninsulated surface;
b) texturizing said uninsulated surface of said conductive member;
c) preparing a liquid solution comprising a polymeric membrane formulation comprising an ionophore responsive to protamine or heparin and a solvent;
d) coating the texturized surface of said conductive member with said liquid solution so that the liquid solution is in direct contact with said texturized surface; and
e) evaporating the solvent to form an ion selective membrane that is in direct contact with, and adheres to, said conductive member, thereby forming an ion-sensing electrode having a structurally strong ion selective membrane.

92. The method of claim 91 wherein said electrically conductive member is selected from the group consisting of silver, copper, platinum, gold, palladium, iridium, aluminum, nickel, stainless steel, iron, and mixtures thereof.

93. The method of claim 91 wherein said insulated electrically conductive member is an insulated wire and said uninsulated surface is formed by cutting said insulation away from one surface of said wire.

94. The method of claim 91 wherein said uninsulated surface is texturized by beadblasting said uninsulated surface.

95. The method of claim 91 wherein said electrically conductive member comprises an electrically conductive metal deposited onto a portion of a non-conductive substrate.

96. The method of claim 91 wherein said layer of electrical insulation is comprised of a material selected from the group consisting of poly(vinyl chloride), copolymers of poly(vinyl chloride), polymers compatible with polyvinyl chloride, polyethylene, polypropylene, nylon, and silicone rubber.

97. The method of claim 91 wherein said polymer membrane formulation further comprises a polymer matrix material and a plasticizer.

98. The method of claim 91 wherein said ionophore responsive to protamine is a negatively charged lipophilic anion.

99. The method of claim 98 wherein the negatively charged lipophilic anion is derived from a salt of a sulfonate, organoborate, organophosphate or organophosphonate.

100. The method of claim 99 wherein said salt of a sulfonate is dinonylnaphthalene sulfonate, didodecylnaphthalene sulfonate, or dihexadecylnaphthalene sulfonate.

101. The method of claim 99 wherein said salt of an organoborate is a salt of a tetraphenylborate selected from the group consisting of sodium tetraphenylborate, potassium tetrakis(4-chlorophenyl) borate, tetraphenylammonium tetraphenyl borate, sodium tetrakis[3,5-bis-(trifluoromethyl)phenyl]borate, and potassium tetrakis[3,5-bis(trifluoromethyl)phenyl]borate.

102. The method of claim 101 wherein the salt of a tetraphenylborate is potassium tetrakis(4-chlorophenyl) borate.

103. The method of claim 99 wherein said salt of an organophosphate or organophosphonate is selected from the group consisting of calcium bis[4-(1,1,3,3,-tetramethylbutyl)phenyl] phosphate, dioctylphenyl phosphonate, and tris(2-ethylhexyl) phosphate.

104. The method of claim 103 wherein said salt of an organophosphate is calcium bis[4-(1,1,3,3,-tetramethylbutyl)phenyl] phosphate.

105. The method of claim 91 wherein said ionophore responsive to heparin is selected from the group consisting of quaternary ammonium salts, quaternary phosphonium salts, and quaternary arsonium salts.

106. The method of claim 105 wherein said ionophore is a quaternary ammonium salt.

107. The method of claim 105 wherein said quaternary ammonium salt is selected from the group consisting of triethylphenylammonium iodide, tetrapentylammonium bromide, trimethylphenylammonium chloride, dimethyldioctadecylammonium bromide, tetraoctylammonium bromide, hexadecyltrimethylammonium bromide, tetraethylammonium perchlorate, tetramethylammonium bromide, tetrabutylammonium iodide, tridodecylmethylammonium chloride, polybrene, and trioctylmethylammoniumchloride.

108. The method of claim 107 wherein said quaternary ammonium salt is tridodecyl methyl ammonium chloride.

109. The method of claim 91 wherein said polymer matrix material is a film-forming, hydrophobic polymer or copolymer.

110. The method of claim 109 wherein said polymeric matrix material is selected from the group consisting of poly(vinyl chloride), polyurethane, cellulose triacetate, poly(vinyl alcohol)/poly(vinyl chloride) copolymer, and silicone rubber.

111. The method of claim 110 wherein said polymeric matrix material is poly(vinyl chloride).

112. The method of claim 97 wherein said plasticizer is one or more plasticizers selected from the group consisting of 2-nitrophenyloctyl ether, dioctyl phthalate, dioctyl sebacate, dioctyl adipate, dibutyl sebacate, dibutyl phthalate, 1-decanol, 5-phenyl-1-pentanol, tetraundecyl benzhydrol 3,3′,4,4′ tetracarboxylate, benzyl ether, dioctylphenyl phosphonate, tris(2-ethylhexyl) phosphate, and fluorophenyl nitrophenyl ether.

113. The method of claim 1 12 wherein said plasticizer is 2-nitrophenyl octyl ether.

114. The method of claim 112 wherein said plasticizer is tris(2-ethylhexyl) phosphate.

115. The method of claim 97 wherein said ion-selective polymer membrane comprises, in admixture, about 0.1 to 5 percent by weight of said ionophore selective for protamine or said ionophore selective for heparin, about 30 to 70 percent by weight of said plasticizer, and about 30 to 70 percent by weight of said polymer matrix material.

116. A method for producing an ion-sensing electrode having a structurally strong ion selective membrane, said method comprising:
a) forming an electrically conductive member electrically insulated with a layer of electrical insulation, said conductive member having an uninsulated surface;
b) texturizing said uninsulated surface of said conductive member;
c) preparing a liquid solution comprising a polymeric membrane formulation comprising a solvent and a negatively charged lipophilic anion responsive to protamine, said anion selected from the group consisting of dinonylnaphthalene sulfonate, didodecylnaphthalene sulfonate, and dihexadecylnaphthalene sulfonate;
d) coating the texturized surface of said conductive member with said liquid solution so that the liquid solution is in direct contact with said texturized surface; and
e) evaporating the solvent to form an ion selective membrane that is in direct contact with, and adheres to, said conductive member, thereby forming an ion-sensing electrode having a structurally strong ion selective membrane.
